(19) United States
(12) Patent Application Publication
(10) Pub. No.: US 2004/0038649 A1
(43) Pub. Date: Feb. 26, 2004

(54) Zero intermediate frequency to low intermediate frequency receiver architecture

(76) Inventors: Qiang Lin, Pasadena, CA (US); Meng-Chang Doong, Alhambra, CA (US); Dennis Lai, Cerritos, CA (US)

Correspondence Address: Gregory J. Michelson, MacPHERSON KWOK CHEN & HEID LLP, Suite 210, 2402 Michelson Drive, Irvine, CA, 92612, US

(21) Appl. No.: 10/228,780

(22) Filed: Aug. 26, 2002

(51) Int. Cl. H04B 1/18; H04B 1/00; H04B 17/02

(52) U.S. Cl. 455/130; 455/189.1; 455/137; 455/146

(57) ABSTRACT

A transceiver is disclosed having a zero intermediate frequency to low intermediate frequency receiver and a direct upconversion transmitter. Calibrations may be performed to minimize direct current voltage offset and in-phase and quadrature-phase path mismatch after downconversion. Automatic gain control is performed prior to downconversion and after upconversion to minimize the introduction of mismatch.

### BACKGROUND

1. Technical Field

The present invention relates generally to communication systems and, more particularly, to transmitter and receiver architectures.

2. Related Art

There are many types of transmitters and receivers utilized by communication systems. For example, one type of receiver is a superheterodyne receiver, which downconverts a selected incoming frequency by heterodyne action (i.e., mixing two or more signals in a nonlinear device) to a common intermediate frequency where amplification and filtering are provided prior to recovering the baseband signal. A low intermediate frequency (LIF) receiver, which may be viewed as a type of superheterodyne receiver, downconverts the incoming high-frequency signal (e.g., a radio frequency (RF) signal) to a low intermediate frequency prior to further downconversion and recovery of the baseband (information) signal.

A drawback of conventional superheterodyne receivers is that multiple frequency conversions are typically performed, which generate undesired image signals that interfere with the acquisition of the desired signal. High-performance bandpass filters (e.g., surface acoustic wave (SAW) filters) are typically utilized to filter out the undesired image signals, especially the undesired image signals that are adjacent in frequency to the desired signal. However, high-performance bandpass filters and numerous local oscillators add to the complexity, cost, and size of the superheterodyne receiver.

A zero intermediate frequency (ZIF) receiver is another example of a receiver architecture. ZIF receivers demodulate the incoming signal directly to in-phase and quadrature-phase (I/Q) baseband signals that are then amplified, filtered, and processed. ZIF receivers do not require the bandpass filters used by LIF receivers, because undesired image signals are not generated or any necessary filtering can be performed with inexpensive lowpass filters operating at baseband frequencies rather than at intermediate frequencies.

A drawback of ZIF receivers is that there are two signal paths (i.e., the in-phase path and the quadrature-phase path), which tends to result in mismatch occurring between the two signal paths, and consequently, signal quality degradation. Furthermore, direct current (DC) offset associated with direct downconversion is also amplified by the baseband amplifier stages, which causes eventual saturation in the amplifiers and synchronization problems with the baseband signal processing. These drawbacks are very significant when a high-quality signal is required by the baseband processor, such as in a fading channel environment, and may require complicated compensation techniques. As a result, there is a need for an improved receiver architecture.

### BRIEF SUMMARY

Transmitter and receiver architectures are disclosed herein. For example, in accordance with an embodiment of the present invention, a zero intermediate frequency (ZIF) to low intermediate frequency (LIF) receiver is provided that retains the advantages associated with direct downconverter receivers (e.g., ZIF receivers) and multiple downconverter receivers (e.g., LIF receivers), while eliminating or reducing their disadvantages.

The ZIF-to-LIF receiver provides image signal interference rejection without using expensive bandpass filters (e.g., SAW filters) required by conventional LIF receivers. The ZIF-to-LIF receiver also minimizes or eliminates the DC product and I/Q mismatch problems associated with conventional ZIF receivers. The ZIF-to-LIF receiver achieves significant performance improvements (e.g., in terms of packet error rate (PER) or bit error rate (BER)) without sacrificing hardware implementation simplicity. Furthermore, the ZIF-to-LIF receiver can be implemented with many different types of transmitters using various types of frequency plans, which permits a wide degree of design flexibility.

More specifically, in accordance with one embodiment of the present invention, a receiver includes a first and second mixer to downconvert a received signal into an in-phase signal and a quadrature-phase signal; a first and second lowpass filter, coupled respectively to the first and second mixer, to filter the in-phase signal and the quadrature-phase signal; and a third and fourth mixer, coupled respectively to the first and second lowpass filter, to upconvert the in-phase signal and the quadrature-phase signal to an intermediate frequency.

In accordance with another embodiment of the present invention, a communication device includes a receiver having means for receiving at least one signal and downconverting the at least one signal to baseband signals; means for filtering the baseband signals; and means for upconverting and summing the baseband signals to provide a low intermediate frequency signal. The communication device further includes a transmitter having means for receiving a first baseband signal and upconverting the first baseband signal to a transmission frequency.

In accordance with another embodiment of the present invention, a method of receiving a signal includes amplifying a received signal; downconverting the received signal to baseband signals; filtering the baseband signals to remove interference; upconverting the baseband signals to an intermediate frequency and summing to provide an intermediate frequency signal; and amplifying the intermediate frequency signal.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows a block diagram illustrating a transceiver architecture in accordance with an embodiment of the present invention.

FIG. 2 shows a block diagram illustrating a transceiver architecture in accordance with an embodiment of the present invention.

FIG. 3 shows a block diagram illustrating a demodulation and DC canceling technique in accordance with an embodiment of the present invention.

FIG. 4 shows a plot of exemplary signals in the frequency domain in accordance with an embodiment of the present invention.

FIG. 5 shows a plot of exemplary signals and filtering in the frequency domain in accordance with an embodiment of the present invention.

FIG. 6 shows a flowchart for direct current compensation in accordance with an embodiment of the present invention.

FIG. 7 shows a block diagram illustrating an upconversion technique in accordance with an embodiment of the present invention.

FIG. 8 shows a plot of exemplary signals in the frequency domain after upconversion in accordance with an embodiment of the present invention.

FIG. 9 shows a block diagram illustrating a lowpass filter calibration technique in accordance with an embodiment of the present invention.

FIG. 10 shows a flowchart for the lowpass filter gain and bandwidth calibration technique in accordance with an embodiment of the present invention.

The preferred embodiments of the present invention and their advantages are best understood by referring to the detailed description that follows. It should be appreciated that like reference numerals are used to identify like elements illustrated in one or more of the figures.

### DETAILED DESCRIPTION

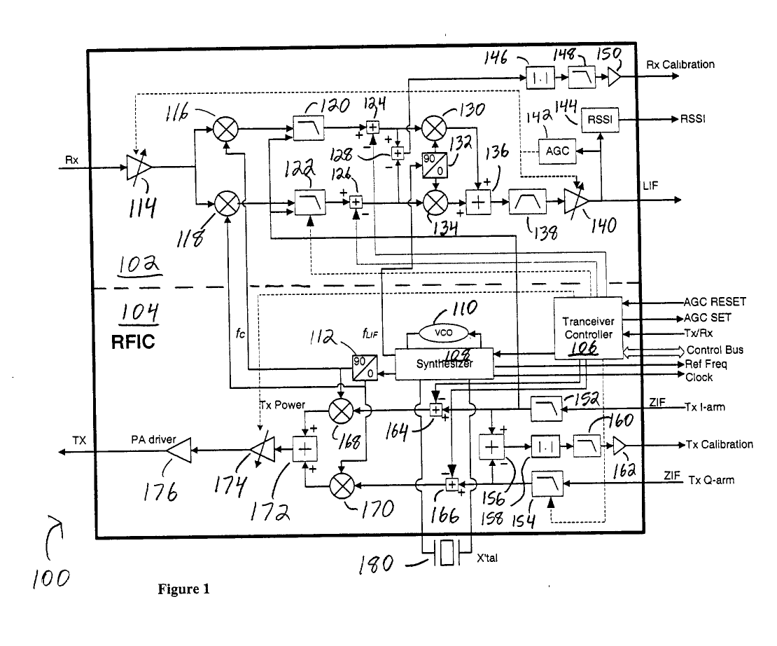

FIG. 1 shows a block diagram illustrating a transceiver 100 in accordance with an embodiment of the present invention. Transceiver 100 represents any type of device that provides transmit and receive capabilities. For example, transceiver 100 is an integrated circuit (e.g., a radio frequency integrated circuit (RFIC)) that is designed to receive and transmit RF signals.

As discussed further herein, a separate integrated circuit that operates at baseband frequencies (e.g., a baseband integrated circuit (BBIC)) may function in conjunction with transceiver 100, for example, to process the downconverted incoming signals provided by transceiver 100 or provide outgoing signals for upconversion and transmission by transceiver 100. Alternatively, transceiver 100 may be designed to incorporate the functions of the BBIC. However, this exemplary embodiment is not limiting and transceiver 100 may be designed as one integrated circuit or as multiple integrated circuits (e.g., separate receiver, transmitter, and/or control or processor integrated circuits), depending upon the specific application.

Transceiver 100 includes generally a receiver portion 102 and a transmitter portion 104, whose general boundaries are as shown in FIG. 1. Receiver portion 102 illustrates an exemplary implementation for a ZIF-to-LIF receiver architecture. Transmitter portion 104 illustrates an exemplary implementation for a transmitter architecture that complements the ZIF-to-LIF receiver architecture by minimizing the associated complexity, as discussed further herein. However, the exemplary implementation shown in transmitter portion 104 is not limiting and alternative transmitter architectures may be selected to work in conjunction with the ZIF-to-LIF receiver architecture, depending upon the application (e.g., frequency plan or system requirements).

Transceiver 100 further includes a transceiver controller 106, a frequency synthesizer 108, a voltage controlled oscillator (VCO) 110, and a phase shifter 112. These elements are shown as part of transmitter portion 104, but alternatively could be represented as part of receiver portion 102 or as a separate control circuitry portion that is part of or separate from transceiver 100.

In this exemplary implementation, transceiver controller 106 controls various functions or components of transceiver 100 and communicates with the BBIC (not shown) to pass various information, such as status and control signals. For example, an automatic gain control (AGC) reset signal is sent from the BBIC to transceiver controller 106 to initiate the AGC process for transceiver 100. An AGC set signal is sent from transceiver controller 106 to the BBIC when the AGC process has completed.

A transmit/receive (Tx/Rx) signal is sent from the BBIC to transceiver controller 106 to initiate signal transmission or reception, due to transceiver 100 being a half-duplex system. Alternatively, transceiver 100 could be implemented as a full-duplex system to allow simultaneous transmission and reception of signals. A control bus is also provided for communicating various other signals (e.g., status or control signals) between transceiver controller 106 and the BBIC.

Transceiver controller 106 communicates with various components on transceiver 100, as discussed further herein, to control or adjust various functions or parameters of transceiver 100. Transceiver controller 106 controls the gain of the variable amplifiers, such as a low noise amplifier (LNA) 114 or a preamplifier 174. Transceiver controller 106 also sends control signals to frequency synthesizer 108 to set or control, for example, the frequencies of signals provided by frequency synthesizer 108. A crystal oscillator 180 and VCO 110 assist frequency synthesizer 108 to provide an intermediate frequency (f_{LIF}) signal and a carrier frequency (f_{c}) signal. Frequency synthesizer 108 also provides a reference frequency (Ref Freq) signal and a clock signal, which can be utilized, for example, by the BBIC.

Receiver portion 102 performs the ZIF-to-LIF receiver process on a received (Rx) signal. The Rx signal enters LNA 114 for initial amplification prior to downconversion to baseband through the use of mixers 116 and 118. Mixer 116 receives the carrier frequency signal from frequency synthesizer 108, shifted 90° by phase shifter 112, while mixer 118 receives the carrier frequency signal with no phase shift to generate in-phase and quadrature-phase (I/Q) baseband signals.

The I/Q baseband signals are filtered by lowpass filters 120 and 122 prior to upconversion to the intermediate frequency (e.g., 20 MHz) through the use of mixers 130 and 134. Mixer 130 receives the intermediate frequency signal from frequency synthesizer 108, shifted 90° by a phase shifter 132, while mixer 134 receives the intermediate frequency signal with no phase shift to generate I/Q intermediate frequency signals. A summer 136 adds the I/Q intermediate frequency signals to provide a low intermediate frequency (LIF) signal that is filtered by a bandpass filter 138 and amplified by an amplifier 140.

The LIF signal is then provided to a signal processor (e.g., the BBIC) where signal demodulation and processing may occur to extract or process the information. Because the LIF signal is not at baseband frequencies, AC coupling may be utilized between amplifier stages and between transceiver 100 and the BBIC. As an example, amplifier 140 may represent several amplifier stages joined through AC coupling. Analog-to-digital conversion (ADC) and signal processing may then be performed by the BBIC on the LIF signal to extract the desired information.

Transmitter portion 104 receives, from the BBIC, I/Q baseband transmit signals through its corresponding transmit I/Q paths (labeled Tx I-arm and Tx Q-arm, respectively). The I/Q baseband transmit signals are filtered by corresponding lowpass filters 152 and 154 prior to upconversion to a transmit frequency through the use of mixers 168 and 170, utilizing the carrier frequency signal from frequency synthesizer 108 that is shifted 90° and 0°, respectively, by phase shifter 112. The I/Q baseband transmit signals that have been upconverted are then added by a summer 172 and amplified by a pre-amplifier 174 and a power amplifier (PA driver) 176, prior to transmission as a transmit (Tx) signal.

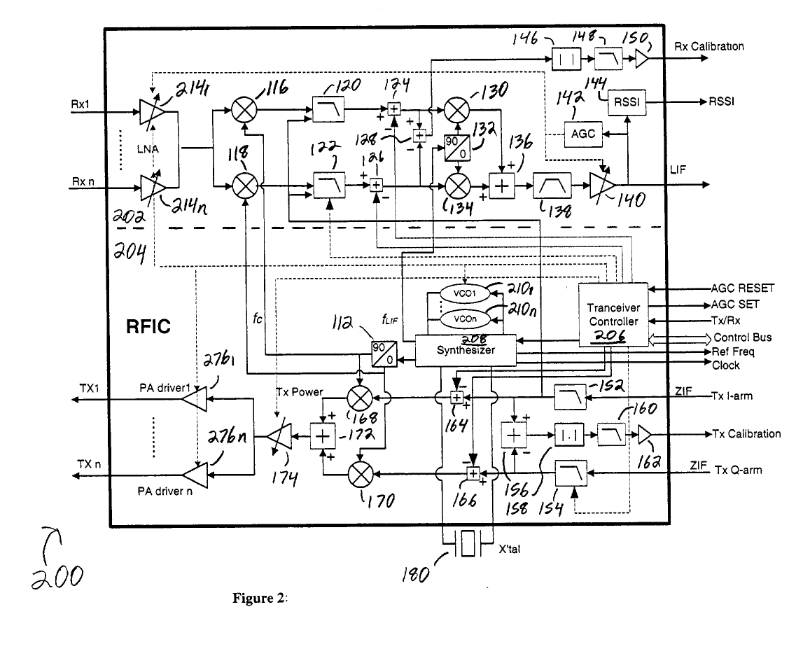

FIG. 1 illustrates transceiver 100 that supports singleband half-duplex communication. However, the principles of transceiver 100 can be extended to multiple bands (e.g., channels) and/or full duplex operation. For example, referring briefly to FIG. 2, a transceiver 200 is illustrated in accordance with an embodiment of the present invention. Transceiver 200 is similar to transceiver 100 (FIG. 1), with many of the techniques or principles discussed herein in reference to FIG. 1 applying equally or in an equivalent fashion to FIG. 2 and, therefore, these discussions are not repeated.

Transceiver 200 provides one exemplary technique for supporting multiple band, half duplex operation. Transceiver 200 includes a transceiver controller 206, a frequency synthesizer 208, VCOs 210 (which are separately referenced as VCO 210₁ through VCO 210ₙ), LNAs 214 (which are separately referenced as LNA 214₁ through LNA 214ₙ), and PA drivers 276 (which are separately referenced as PA driver 276₁ through PA driver 276ₙ), where “n” equals the number of supported carrier frequencies.

As shown in FIG. 2, transceiver controller 206 selects which one of LNAs 214 to operate to receive one of corresponding received signals (i.e., Rx₁ through Rxₙ) for conversion by the ZIF-to-LIF receiver architecture (i.e., a receiver portion 202). Transceiver controller 206 also selects through frequency synthesizer 208 and VCOs 210 the frequency of the carrier frequency signal and the intermediate frequency signal to be utilized by the ZIF-to-LIF receiver architecture or mixers 168 and 170. Transceiver controller 206 further selects, for a transmitter portion 204, which PA drivers 276 to operate for transmission of transmit signals (i.e., Tx₁ through Txₙ).

In this fashion, LNAs 214 and PA drivers 276 can be optimized for their intended frequency band of operation. For example, transceiver 200 could support two frequency bands, such as 2.4 GHz (e.g., IEEE 802.11a standard) and 5 GHz (e.g., IEEE 802.11b standard) by utilizing two of VCOs 210, LNAs 214, and PA drivers 276 (i.e., VCO 210₁ and 210₂, LNA 214₁ and 214₂, and PA drivers 276₁ and 276₂). LNA 214₁ and PA driver 276₁ could be optimized for operation at 2.4 GHz, while LNA 214₂ and PA driver 276₂ could be optimized for operation at 5 GHz. Transceivers 100 and 200 could also be utilized in a full duplex manner by utilizing techniques known in the art (e.g., employing multiple antennas and/or shielding or isolation of the transmitter and receiver circuits).

Returning to FIG. 1, transceiver 100 includes techniques for setting or adjusting automatic gain control (AGC), providing DC offset cancellation, and minimizing filter gain and/or bandwidth mismatch. Specifically, transceiver 100 includes an AGC module 142 that monitors the output of amplifier 140 (i.e., the LIF signal). AGC module 142, under the control of transceiver controller 106, determines and sets the amount of gain for the amplifiers (e.g., LNA 114 and amplifier 140) in the ZIF-to-LIF receiver to maintain adequate gain and prevent amplifier saturation.

AGC is performed prior to downconversion (i.e., in LNA 114 at the carrier frequency) and after upconversion (i.e., in amplifier 140 at the intermediate frequency) to avoid introducing an imbalance in the in-phase or quadrature-phase path of the baseband signal (i.e., the path through lowpass filters 122 and 120, respectively). AGC may be performed initially, for example, when a signal is detected by a received signal strength indicator (RSSI) circuit 144 that notifies the BBIC, which in turn asserts the AGC reset signal and allows transceiver controller 106 to initiate the AGC process.

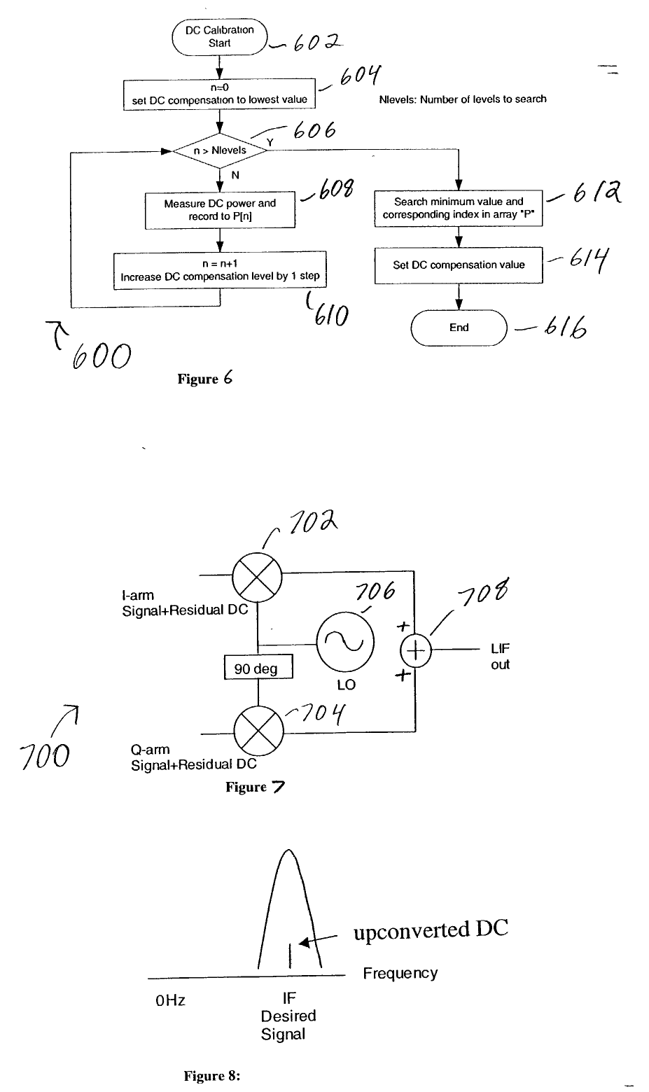

DC offset cancellation is performed in transceiver 100 to minimize erroneous DC voltage signals (i.e., DC offset) introduced during the downconversion process performed by mixers 116 and 118. The DC offset can be measured on the LIF signal (output of amplifier 140), for example, by the BBIC when no signal is present at the input of LNA 114. The BBIC demodulates the LIF signal and measures the DC offset of the in-phase signal and the quadrature-phase signal. The BBIC along with transceiver controller 106 may perform a calibration algorithm, as discussed herein in reference to FIG. 6, to minimize the DC offset in each path (i.e., the I and Q path). Transceiver controller 106 can then provide a determined DC cancellation signal to a subtractor 124 and/or to a subtractor 126 to minimize the DC offset in one or both I/Q paths.

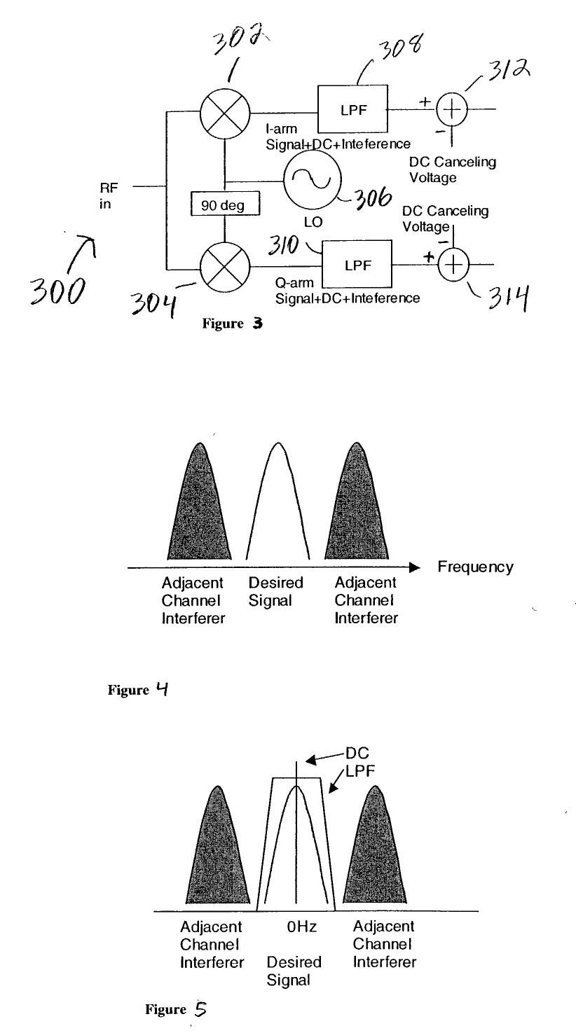

The DC offset cancellation technique is further illustrated in FIGS. 3 through 6 in accordance with an embodiment of the present invention. In FIG. 3, an RF input (RF in) signal is downconverted to an in-phase baseband signal and a quadrature-phase (I/Q) baseband signal by utilizing a local oscillator 306 and mixers 302 and 304. The RF input signal is shown in an exemplary representation in FIG. 4 as a plot of amplitude versus frequency. The plot shows the desired signal along with adjacent channel interferers.

After downconversion of the RF input signal, the I/Q baseband signals are as shown in FIG. 5 as a plot of amplitude versus frequency. The I/Q baseband signals each include the desired signal, interference (e.g., the adjacent channel interferers, noise, and other undesired high-frequency signals), and the DC offset (generated during the downconversion process). Lowpass filters 308 and 310 (FIG. 3) can be used to remove the adjacent channel interferers as illustrated in FIG. 5, which shows an exemplary passband (labeled LPF) for lowpass filters 308 and 310. However, the DC offset (labeled DC in FIG. 5) at zero hertz cannot be removed by lowpass filters 308 and 310.

As shown in FIG. 3, a DC canceling voltage is subtracted from the in-phase baseband signal and/or the quadrature-phase baseband signal using subtractors 312 and 314. The value of the DC canceling voltage for each I/Q path may be determined, for example, by external circuitry, such as the BBIC as discussed in reference to FIG. 1. A flowchart 600 is shown in FIG. 6 that illustrates exemplary DC calibration steps (applicable for FIGS. 1, 2, and 3) for determining a value for the DC canceling voltage in accordance with an embodiment of the present invention.

Step 602 starts the DC calibration process and step 604 sets a counter “n” to zero and sets DC compensation values (i.e., DC canceling voltages) to their lowest values. Step 606 compares the counter n to a variable Nlevels that is equal to the number of DC compensation value levels (i.e., the number of DC canceling voltage values available). If the counter n is less than the variable Nlevels, step 608 measures the DC power or DC offset and then stores the value in an array P[n].

Step 610 increments the counter n and increases the DC compensation level by one step. Steps 608 and 610 are repeated until all of the DC compensation levels have been tested. Step 612 searches for the minimum DC power value and associated index (i.e., value of the counter n), which corresponds with the DC compensation value that minimizes the DC offset. The DC compensation value or DC canceling voltage can then be applied (step 614), such as discussed above in reference to FIGS. 1, 2, and 3, and the DC calibration process ends (step 616).

After the DC calibration process is completed for each path and the DC canceling voltages applied (e.g., such as in FIG. 3), there may still be some residual DC component remaining that cannot be removed by the DC calibration process (e.g., due to the coarseness of the graduation steps of the DC compensation values). The residual DC component will be upconverted along with the desired signal as illustrated in FIGS. 7 and 8, which show a modulation technique in accordance with an embodiment of the present invention. In FIG. 7, the I/Q baseband signals, which include the desired signal and the residual DC component, are upconverted by utilizing a local oscillator 706 and mixers 702 and 704 and then added by a summer 708 to provide an output signal (labeled LIF out).

FIG. 8 shows an exemplary plot of the output signal (LIF out) in the frequency domain after upconversion (as discussed in reference to FIG. 7). As illustrated, there is the residual DC component (labeled upconverted DC) at the IF frequency along with the desired signal. However, because the residual DC component is at a level significantly lower than the signal level of the desired signal, the impact of the residual DC component's presence is negligible.

The output signal (LIF out) can be amplified to a desired signal level, demodulated, and decoded. Furthermore, because no useful information is contained in the DC component that may occur in the following stages, AC coupling can be used between amplifier stages as well as between the upconverter circuits and the demodulation and decoding circuits (e.g., between the RFIC and the BBIC) to avoid introducing additional DC offset which leads to saturation of the amplifiers. The residual DC component may be minimized further, for example, by using techniques discussed in U.S. patent applications No. [attorney docket M-15026 US] entitled “Enhanced DC Offset Mitigation” by inventors Asim Loan, Meng-Chang Doong, and Dennis Lai, which is incorporated herein by reference in its entirety.

Returning again to FIG. 1, the filter gain and/or filter bandwidth mismatch, which is introduced by lowpass filters 120 and 122 and results in I/Q mismatch (i.e., signal mismatch between the in-phase path and the quadrature-phase path after lowpass filters 122 and 120, respectively), may be measured and minimized by fine adjustments in the gain and the bandwidth of lowpass filters 120 and 122. Similarly for transmitter portion 104, the filter gain and/or bandwidth mismatch introduced by lowpass filters 152 and 154 may be measured and minimized by fine adjustments in the gain and the bandwidth of lowpass filters 152 and 154.

The I/Q mismatch introduced by lowpass filters 120 and 122 can be measured using a receiver calibration (Rx calibration) signal. The receiver calibration signal path includes a subtractor 128, an absolute magnitude circuit 146, a lowpass filter 148, and an amplifier 150. Subtractor 128 subtracts the output from lowpass filter 122 from the output from lowpass filter 120. Absolute magnitude circuit 146 takes the absolute value of the resulting signal from subtractor 128, which is then filtered and amplified by lowpass filter 148 and amplifier 150, respectively, to generate the receiver calibration signal.

The I/Q mismatch introduced by lowpass filters 152 and 154 can be measured using a transmitter calibration (Tx calibration) signal. The transmitter calibration signal path includes a subtractor 156, an absolute magnitude circuit 158, a lowpass filter 160, and an amplifier 162. Subtractor 156 subtracts the output from lowpass filter 154 from the output from lowpass filter 152. Absolute magnitude circuit 158 takes the absolute value of the resulting signal from subtractor 156, which is then filtered and amplified by lowpass filter 160 and amplifier 162, respectively, to generate the transmitter calibration signal. The direct upconversion technique utilized by transmitter portion 104 also helps to minimize mismatch, because most of the transmit path occurs with the upconverted signal (e.g., at RF frequencies) rather than on the separate I/Q baseband transmit signals.

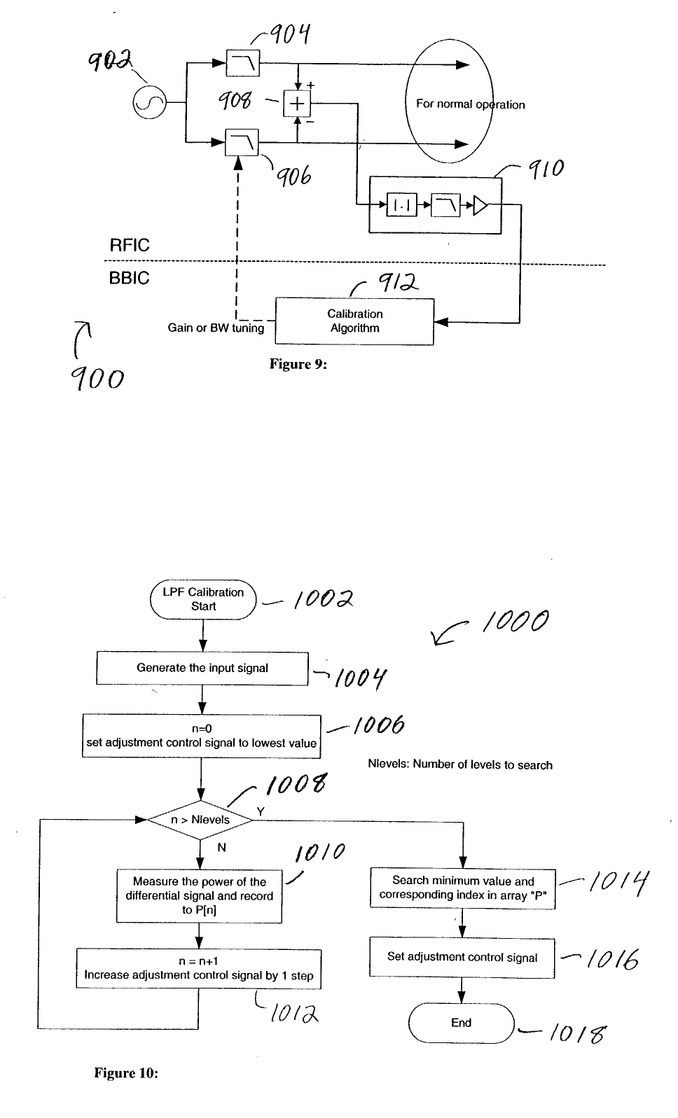

For example, the BBIC can receive the transmitter calibration signal or the receiver calibration signal, which provide measurements associated with the filter gain or bandwidth mismatch, and perform a calibration technique, as discussed herein in reference to FIGS. 9 and 10, to minimize the mismatch. Transceiver controller 106 can be utilized, as shown in FIG. 1, to directly adjust the gain and the bandwidth of lowpass filters 120, 122, 152, and/or 154.

The filter gain mismatch can be calibrated using a low frequency signal (e.g., 312.5 KHz) that is fed to both lowpass filters (i.e., lowpass filters 120 and 122 or lowpass filters 152 and 154). A low frequency signal is employed to minimize the influence of filter bandwidth mismatch that may exist. For example for the receiver portion 102, the low frequency signal may be supplied to lowpass filters 120 and 122 using a signal generated on the in-phase baseband transmit signal path (taken, as shown in FIG. 1, after lowpass filter 152). For the transmitter portion 104, the low frequency signal may be generated and supplied to lowpass filters 152 and 154 using signals generated on the corresponding in-phase and quadrature-phase baseband transmit signal paths.

The filter bandwidth mismatch results in differential delay at the outputs of the lowpass filters and higher frequency signals magnify this characteristic. For example, the filter bandwidth mismatch can be calibrated using a higher frequency signal (e.g., 8.125 MHz) fed to the lowpass filters in a similar fashion as discussed above for the filter gain mismatch.

If the gain and bandwidth between the I/Q paths has minimal mismatch, the amplitude of the differential signal (i.e., the receiver calibration signal or the transmitter calibration signal) will be small. By measuring the difference between the I/Q paths and through calibration for the gain using the low frequency signal and then for the bandwidth using the higher frequency signal (or vice versa), the differential signal and, consequently, the I/Q mismatch can be minimized.

FIGS. 9 and 10 illustrate an exemplary calibration algorithm for performing the I/Q mismatch calibration that is applicable for FIGS. 1 and 2 in accordance with an embodiment of the present invention. As shown in FIG. 9, a local oscillator 902 provides a signal to lowpass filters 904 and 906 and a subtractor 908 generates a differential signal from their output signals. A circuit 910 takes the absolute value of the differential signal and then filters and amplifies it to obtain a representative amplitude of the differential signal (i.e., the receiver calibration signal or the transmitter calibration signal), which is provided to a calibration algorithm 912. Calibration algorithm 912 provides gain or bandwidth tuning for lowpass filters 904 and 906.

As illustrated in FIG. 9, calibration algorithm 912 may be performed by the BBIC by providing directly to the lowpass filters the appropriate gain or bandwidth tuning. Alternatively, calibration algorithm 912 may be performed by the BBIC in conjunction with transceiver controller 106 or solely by transceiver controller 106 by incorporating the BBIC functions, depending upon the application requirements.

A flowchart 1000 is shown in FIG. 10 that illustrates exemplary lowpass filter gain and bandwidth calibration steps in accordance with an embodiment of the present invention. Specifically, the steps in flowchart 1000 may be performed to calibrate the lowpass filter gain mismatch and then performed again to calibrate the lowpass filter bandwidth mismatch.

Step 1002 starts the lowpass filter calibration process and step 1004 generates the input signal for the lowpass filters. Step 1006 sets a counter “n” to zero and sets an adjustment control signal to its lowest value. Step 1008 compares the counter n to a variable Nlevels (i.e., the number of adjustment control signal levels). If the counter n is less than the variable Nlevels, step 1010 measures the power of the differential signal and then stores the value in an array P[n].

Step 1012 increments the counter n and increases the adjustment control signal by one step or level. Steps 1010 and 1012 are repeated until all of the adjustment control signal levels have been tested. Step 1014 searches for the minimum power measurement and associated index (i.e., value of the counter n), which corresponds with the adjustment control signal value that minimizes the lowpass filter gain or bandwidth mismatch (depending upon which is being calibrated). The adjustment control signal values that are determined during the calibration process can then be used to tune the appropriate filter to minimize I/Q mismatch.

The ZIF-to-LIF receiver, such as exemplified in FIGS. 1 and 2, is applicable to any wired or wireless communication system to improve performance and reduce costs. For example, the ZIF-to-LIF receiver may offer fewer components or less expensive components, a simpler and more elegant design, and consume less area (e.g., circuit board space) than conventional alternatives. Exemplary applications include cable television (CATV) systems, wireless local area network (LAN), wireless home area network (HAN), and third generation partnership project (3GPP) systems.

The ZIF-to-LIF receiver downconverts the incoming signal to baseband and filters out interferences prior to upconverting the baseband signal to an intermediate frequency for further amplification. Because amplification is accomplished at an intermediate frequency instead of baseband, AC coupling can be utilized between amplifier stages to eliminate saturation problems associated with the baseband DC offset. Furthermore, because the baseband stage utilizes only minimal signal processing (e.g., lowpass filters with fixed gain), the gain and phase mismatch between the in-phase path and the quadrature-phase path are minimal. Additionally, automatic gain control (AGC) is performed on the incoming signal at the carrier frequency (i.e., prior to ZIF downconversion) and at the intermediate frequency (i.e., after LIF upconversion) and, consequently, does not introduce further I/Q imbalance.

Embodiments described above illustrate but do not limit the invention. It should also be understood that numerous modifications and variations are possible in accordance with the principles of the present invention. Accordingly, the scope of the invention is defined only by the following claims.

We claim:

1. A receiver comprising:
a first and second mixer to downconvert a received signal into an in-phase signal and a quadrature-phase signal;
a first and second lowpass filter, coupled respectively to the first and second mixer, to filter the in-phase signal and the quadrature-phase signal; and
a third and fourth mixer, coupled respectively to the first and second lowpass filter, to upconvert the in-phase signal and the quadrature-phase signal to an intermediate frequency.

2. The receiver of claim 1, further comprising:
a summing circuit, coupled to the third and fourth mixer, to sum the in-phase signal and the quadrature-phase signal at the intermediate frequency to provide an intermediate frequency signal;
a third filter, coupled to the summing circuit, to filter the intermediate frequency signal; and
a first amplifier, coupled to the third filter, to amplify the intermediate frequency signal.

3. The receiver of claim 2, further comprising a second amplifier, coupled to the first and second mixer, to amplify the received signal prior to downconversion by the first and second mixer.

4. The receiver of claim 3, further comprising at least one additional amplifier, coupled to the first and second mixer, to amplify at least one additional received signal prior to downconversion by the first and second mixer.

5. The receiver of claim 3, further comprising an automatic gain control circuit, coupled to the first and second amplifier, adapted to adjust a gain of the first amplifier and the second amplifier.

6. The receiver of claim 1, further comprising a first and second subtractor circuit, the first subtractor circuit coupled between the first lowpass filter and the third mixer, the second subtractor circuit coupled between the second lowpass filter and the fourth mixer, wherein a corresponding direct current voltage cancellation signal is received by the first and second subtractor circuit to reduce a direct current offset voltage in the corresponding in-phase signal and quadrature-phase signal.

7. The receiver of claim 1, further comprising a subtractor circuit, coupled between output terminals of the first and second lowpass filter, adapted to provide a difference signal from the in-phase signal and the quadrature-phase signal, wherein the difference signal is measured to determine gain or bandwidth adjustments for the first or second lowpass filter.

8. A communication device comprising:
a receiver having means for receiving at least one signal and downconverting the at least one signal to baseband signals;
means for filtering the baseband signals; and
means for upconverting and summing the baseband signals to provide a low intermediate frequency signal; and
a transmitter having means for receiving a first baseband signal and upconverting the first baseband signal to a transmission frequency.

9. The communication device of claim 8, further comprising:
means for amplifying the at least one signal prior to downconverting;
means for amplifying the low intermediate frequency signal; and
means for providing automatic gain control for the amplifying means for the at least one signal and for the low intermediate frequency signal.

10. The communication device of claim 9, further comprising means for measuring and adjusting the gain and bandwidth mismatch for the filtering means.

11. The communication device of claim 10, further comprising means for reducing erroneous direct current voltage signals after downconverting the at least one signal and prior to the upconverting means.

12. The communication device of claim 8, further comprising:
means for filtering the first baseband signal; and
means for measuring and adjusting the gain and bandwidth mismatch for the filtering means for the first baseband signal.

13. A method for receiving a signal, the method comprising:
amplifying a received signal;
downconverting the received signal to baseband signals;
filtering the baseband signals to remove interference;
upconverting the baseband signals to an intermediate frequency and summing to provide an intermediate frequency signal; and
amplifying the intermediate frequency signal.

14. The method of claim 13, further comprising providing automatic gain control for the amplifying operations.

15. The method of claim 14, further comprising minimizing a direct current offset in the baseband signals after the downconverting operation.

16. The method of claim 15, further comprising adjusting gain or bandwidth of the filtering operation to minimize mismatch in the baseband signals.

17. The method of claim 15, wherein the minimizing of the direct current offset further comprises:
providing a plurality of direct current canceling voltages to the baseband signals;
measuring the direct current offset in the baseband signals for each of the plurality of direct current canceling voltages; and
determining and providing the direct current canceling voltage for each of the baseband signals that minimizes the direct current offset.

18. The method of claim 16, wherein the adjusting of the gain or the bandwidth further comprises:
providing a calibration signal to the filtering operation;
providing a plurality of gain adjustments or bandwidth adjustments to the filtering operation;
measuring a difference in the signal through different paths of the filtering operation; and
determining and providing the gain adjustment or the bandwidth adjustment to the filtering operation that minimizes the respective gain mismatch or bandwidth mismatch.
